(19) United States
(12) Patent Application Publication
(10) Pub. No.: US 2014/0174107 A1
(43) Pub. Date: Jun. 26, 2014

(54) SELF-POWERED ENERGY CONVERSION REFRIGERATION APPARATUS

(71) Applicant: Michael D. NEWMAN, Hillsborough, NJ (US)

(72) Inventor: Michael D. NEWMAN, Hillsborough, NJ (US)

(21) Appl. No.: 14/107,263

(22) Filed: Dec. 16, 2013

Related U.S. Application Data
(63) Continuation-in-part of application No. 12/617,156, filed on Nov. 12, 2009, now abandoned.

(51) Int. Cl. F17C 9/04

(52) U.S. Cl. CPC F17C 9/04
USPC 62/50.3

(57) ABSTRACT

An energy conversion apparatus for a freezer includes a housing having a first region therein for receiving liquid CO₂ for providing potential energy; a movable member rotatably mounted to the housing and having a second region in fluid communication with the first region and constructed to receive the liquid CO, for providing kinetic energy from which mechanical work is provided to rotate the movable member; and a discharge member connected to the movable member and having a third region in fluid communication with the second region, the third region continuing the mechanical work when exhausting the liquid CO₂ such that the liquid CO₂ is changed to a CO₂ snow.

### BACKGROUND OF THE INVENTION

The present embodiments relate to apparatus for transferring potential energy of a high pressure, high energy cryogenic fluid into mechanical energy for increasing the amount of refrigeration by decreasing the enthalpy of the fluid for use with, for example cryogenic food freezers.

Powering a fan in a refrigeration apparatus which utilizes a refrigerant fluid discharged directly into the refrigeration chamber requires use of electricity to operate an electric motor for the fan, the motor being mounted. either internally or externally to the refrigeration chamber. Motors consume electrical energy and can add heat to the refrigeration apparatus if they are mounted to or within the refrigeration chamber. Further, internal injection headers required to distribute the refrigerant fluid into the refrigeration chamber consume electricity and produce additional unwanted heat within the chamber.

Such refrigeration apparatus may also have ancillary systems which require electrical energy, such systems to include, but are not limited to, conveying apparatus, thermostat devices, control systems, circulating fans and exhaust fans.

Cryogen for known refrigeration apparatus include carbon dioxide (CO₂) and nitrogen (N₂) stored at high pressures in liquid bulk storage tanks. For example, CO₂ is usually stored at from 280 to 300 psig. The CO₂ is stored as a cryogenic fluid under high pressure and at a high energy state in this storage condition. In known cryogenic applications, for example in food freezing applications, the CO₂ is injected into a process for cooling the cryogenic atmosphere of the freezer, with the fluid traveling from the pressure vessel where the CO₂ is at a high energy state in liquid form through a vacuum insulated pipeline to the point of use which is in the cryogenic food freezer. At the point of use the pipeline terminates in at least one and for many applications a plurality of nozzles in which to distribute the cryogen to the freezer atmosphere. The saturated liquid CO₂ experiences a pressure drop across the nozzle as it expands into the ambient environment of the freezer chamber. Depending upon the enthalpy of the CO₂ before it expands across the nozzle (subcooled, saturated or super-heated state), a particular ratio of the solid CO₂ to gas is created to use, for example in the food freezing application.

Therefore, what is needed is a fan and/or an injection device for refrigeration apparatus which is capable of converting the potential energy of the refrigerant liquid into electrical energy, mechanical energy, or any other method of performing work with the high pressure liquid refrigerant prior to injection, at a lower energy state (subcooled). The captured energy from this process can be used to power various ancillary systems or for other purposes.

### SUMMARY OF THE INVENTION

There is therefore provided an apparatus for transfer of such energy through a fan, turbine or any other rotating device which can be powered by a high pressure, high energy state, cryogenic fluid, such as CO₂ or N₂. Work can be accomplished with the CO₂ before it is passed through the nozzles so that the energy state (enthalpy) of the CO₂ liquid will be reduced. This results in the liquid effectively being subcooled before it passes across the nozzle or nozzles and before it is injected into the freezing chamber of the freezing apparatus. The CO₂ liquid at a lower energy state produces more CO₂ snow and less gas which translates into an increase in refrigeration for the freezing chamber. Energy of the CO₂ liquid is transferred from the high pressure liquid by performing mechanical work, thereby resulting in a liquid at a lower enthalpy which yields an increase in refrigeration for the process while using the same mass of liquid CO₂.

There is therefore provided an energy conversion apparatus for a freezer, which includes a housing having a first region therein for receiving liquid CO₂ at a first pressure and at a first energy state for providing potential energy; a movable member rotatably mounted to the housing and having a second region in fluid communication with the first region, the second region constructed to receive the liquid CO₂ for changing to a second pressure less than the first pressure, and a second energy state less than the first energy state for providing kinetic energy from which mechanical work is provided to rotate the movable member; and a discharge member connected to the movable member and haying a third region in fluid communication with the second region, the third region continuing the mechanical work when exhausting the liquid CO₂ at a third pressure less than the second pressure, and at a third energy state less than the second energy state such that the liquid CO₂ is changed to a CO₂ snow. Another embodiment of the apparatus has the movable member disposed external to the freezing chamber.

There is also provided a method of energy conversion for a freezer, which includes providing liquid CO₂ at a first pressure and at a first energy state to a first region for providing potential energy; expanding the liquid CO₂ to a second pressure less than the first pressure, and to a second energy state less than the first energy state in a second region in fluid communication with the first region for providing kinetic energy for performing mechanical work in the second region; and exhausting the liquid CO₂ as a CO² snow at a third pressure less than the second pressure, and at a third energy state less than the second energy state from a third region in fluid communication with the second region. Another embodiment of the method calls for the providing the kinetic energy and the expanding the liquid CO₂ to occur external to the freezer.

### BRIEF DESCRIPTION OF THE DRAWINGS

For a more complete understanding of the present embodiments, reference may be made to the following detailed description and particular embodiments thereof, taken in conjunction with the following drawings, of which:

FIG. 1 is a side plan view, partially in cross-section, of an embodiment of the fan for refrigerant fluid.

FIG. 2 is a top plan view in cross-section of the embodiment of FIG. 1.

FIG. 3 is a side plan view, partially in cross-section, of an embodiment of a snow injection device.

FIG. 4 is a top plan view of the embodiment of FIG. 3.

FIG. 5 is a side plan view, partially in cross-section, of another embodiment of a snow injection device.

FIG. 6 is a schematic side cut-away view of an embodiment of a self-powered refrigeration apparatus employing the fans as described herein.

FIG. 7 is a schematic side plan view of a turbine apparatus embodiment of the present invention.

FIG. 8 is a schematic end view taken along line 8-8 of the embodiment in FIG. 7.

FIG. 9 is a schematic view in partial cross-section of the embodiment of FIG. 8 mounted for use with a cryogenic freezer.

The present refrigeration apparatus utilizes internal fans with snow injection devices and/or externally mounted turbines which are capable of reducing the energy state (enthalpy) of the cryogen and generating electrical energy.

The fan and snow injection device described herein are operable via energy provided by the refrigerant fluid. No motors are necessary to operate the fan or snow injection device. Energy may be removed from the refrigerant fluid by the fan or snow injection device, and that energy may be used to power other parts of the refrigeration apparatus. Since the refrigerant fluid provides energy to power the fan or snow injection device (performs work), the fluid is delivered into the refrigeration apparatus with less energy, which results in a subcooled fluid, which in turn results in a greater cooling capacity per pound of refrigerant fluid supplied to the refrigeration apparatus. That is, the transfer of energy from the refrigerant fluid ultimately into electrical energy results in a lower energy state refrigerant fluid which increases the refrigerant capacity of the refrigerant fluid. Accordingly, a 15-20% improvement in refrigeration efficiency is realized by the present .

Provided is a fan for refrigerant fluid, comprising at least one blade having an internal space therein through which a refrigerant fluid passes; at least one nozzle in fluid communication with the internal space of the at least one blade, wherein the at least one nozzle discharges the refrigerant fluid from the at least one blade at a velocity sufficient to rotate the at least one blade; and an electrical generator operationally connected to the at least one blade (alternately a mechanical breaking device can be substituted for an electrical generator. Work is performed on this device which generates heat external to the freezing chamber). Alternatively, the fan may comprise a plurality of blades. The refrigerant fluid may be flashed into a mixture of solid and gaseous refrigerant as it is discharged from the at least one blade.

Also provided is a snow injection device for a carbon dioxide (CO₂) refrigerant fluid comprising a disk having an internal space therein through which a CO₂ refrigerant fluid passes; at least one nozzle in communication with the internal space within the disk which discharges the CO₂ refrigerant fluid from the disk at a velocity sufficient to rotate the disk, the at least one nozzle being, adapted to flash the CO₂ refrigerant fluid into gas and solid phases; and an electrical generator (or mechanical break) operationally connected to the disk. Alternatively, the snow injection device may comprise a plurality of nozzles in communication with the internal space in the disk. The snow injection device may further comprise a shroud operatively associated with the snow injection device for causing the solid phase of the flashed CO₂ refrigerant fluid to fall at a reduced velocity out of the device, and into the refrigeration chamber.

The fan and/or snow injection device may further comprise means for storing electricity which are in direct or indirect electrical communication with the electrical generator. The above described nozzles may be high-velocity nozzles, and particularly may be supersonic nozzles. The fan or similar device may also be connected to a mechanical break which releases energy to the environment in the form of heat, thereby removing energy from the cryogenic fluid.

Referring now to FIGS, 1 and 2, an embodiment of the fan shown generally at 10 includes a supply of refrigerant fluid 12, which enters a rotary union 14, proceeds through an internal space 16 of at least one blade 18 and is discharged through nozzle 20. The refrigerant fluid, which may be a cryogen fluid such as liquid carbon dioxide (CO₂), is delivered from a remote source (not shown) through a pipe 11 or conduit into the rotary union 14, the pipe 11 or conduit being in communication with the internal space 16 such that there is a flow of refrigerant fluid from the remote source through the pipe 11 or conduit and rotary union 14 into the internal space 16 of blade 18 or blades.

The blades 18 are engaged with the rotary union 14 such that the rotary union 14 remains stationary as the blades 18 rotate. The internal space 16 may operate as a conduit for the refrigerant fluid 12, or the internal space 16 may be sized and shaped to receive a conduit extending along the fan blade as shown. Such a conduit would be in fluid communication with the pipe 11. The nozzle 20 may be mounted to a tip of the blade 18 and is in fluid communication with the internal space 16 or conduit therein. The nozzle 20 may be a supersonic nozzle and may have its discharge orifice at a right angle with respect to the blade 18. Discharge speeds from the supersonic nozzle may be up to about Mach 3.

As the refrigerant fluid 12 enters the blade 18, it expands and performs work as it moves toward the nozzle 20, forcing the blade 18 to rotate. The nozzle 20 also increases the velocity of the exiting refrigerant fluid and further serves to increase the efficiency of the refrigerator. The refrigerant fluid 12, which may be CO₂, can be either a liquid or a gas as it passes through the blade 18, but upon discharge from the nozzle 20 it flashes into a solid and a gas. In certain embodiments, the fan for refrigerant fluid may additionally comprise one or more blades which do not have the internal spaces 16 therein.

The blades 18 may be operationally connected to or engaged with an electrical generator (not shown) which will function as a mechanical break and will convert the kinetic energy of the rotating blades into electrical energy. Potential energy of the cryogenic fluid at high pressure is converted into kinetic energy upon expansion of the fluid for rotation or movement of the blades 18. The kinetic energy of the moving blades 18 is transferred out of the apparatus or process. As a result, the cryogenic fluid becomes subcooled. Mechanical work is done by the fluid, thereby reducing it's energy state. The blades, as part of a rotor assembly, may be connected to the electrical generator, via a shaft and gear box. In certain embodiments, the shaft may be a low speed shaft that turns a gear which is adapted to turn a second gear connected to a high-speed shaft at a much faster speed than the low-speed shaft turns. The high-speed shaft turns a generator which is housed within a structure which provides a magnetic field. As the generator turns, the magnetic field is altered, thereby generating electricity.

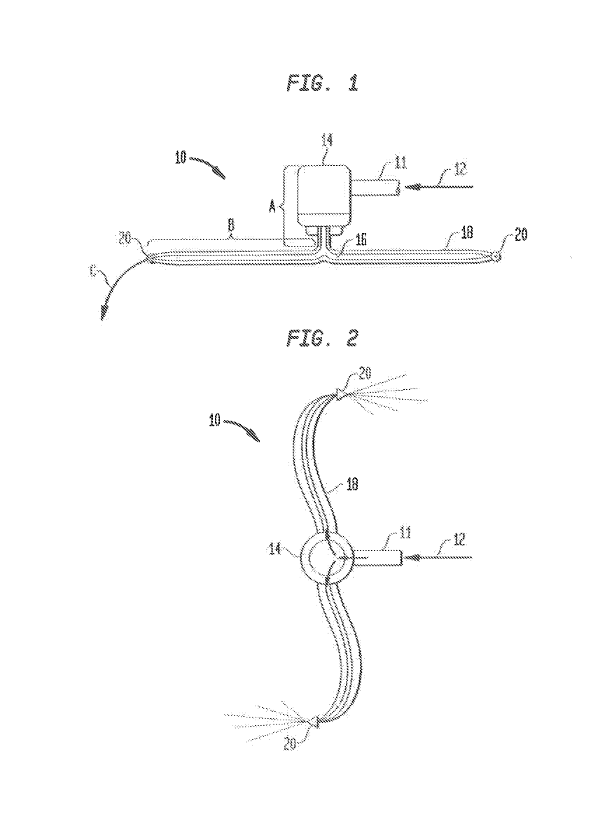

Referring still to FIG. 1, the fan apparatus 10 using the liquid cryogen will have the cryogen at different levels of energy as it proceeds through the apparatus, That is, when the liquid cryogen, such as the liquid CO₂ or liquid N₂, is introduced through the pipe 11 into the union 14, the liquid cryogen has its highest level of energy at the region designated “A”. This is because the liquid cryogen is under a relatively high state of pressure and therefore the energy is similarly at its highest level. As the liquid cryogen moves to the blade 18 and into the internal space 16, the liquid is subcooled as it performs work on the system along the region designated “B”. Along this path the potential energy of the fluid sets the device in motion thereby creating kinetic energy which is transferred out of the apparatus in the form of work. As the liquid CO₂ flows to the end of region “B” it has experienced all possible energy transfer and is at it's lowest, energy state (subcooled). As the CO₂ liquid passes along the region “C” nozzles, because it was previously subcooled within the apparatus, its conversion efficiency is now much higher (higher percentage of CO₂ snow with less CO₂ gas) which results in more refrigeration per unit mass of the CO₂ for the freezing or chilling system it is installed on. Work is performed in region B to rotate the blade 18, such that the CO₂ is exhausted from the region C at its lowest pressure and lowest energy state.

Accordingly, electrical energy extracted from the rotating blades 18 by the electrical generator can be used directly or can be stored in energy storage devices such as capacitors or batteries to provide electrical energy to the ancillary systems of the refrigeration apparatus or for other purposes. Under testing and load conditions, a single fan 10 has been shown to generate in excess of 1.5 horsepower. As a result, while the fans do not require electrical energy in order to function, they can provide electrical energy for other components of the refrigeration apparatus which is converted from the potential energy of the refrigerant fluid. Thus, a refrigeration apparatus which is powered only by the refrigerant fluid may be provided.

For example, but without limitation, the electrical energy generated by the electrical generator may be used to power exhaust fans, conveyor motors, control panels, or other devices associated with the refrigeration apparatus. The electrical energy may be used to power devices or apparatus which are not part of the refrigeration apparatus, or such energy may be sent to the local electrical power grid.

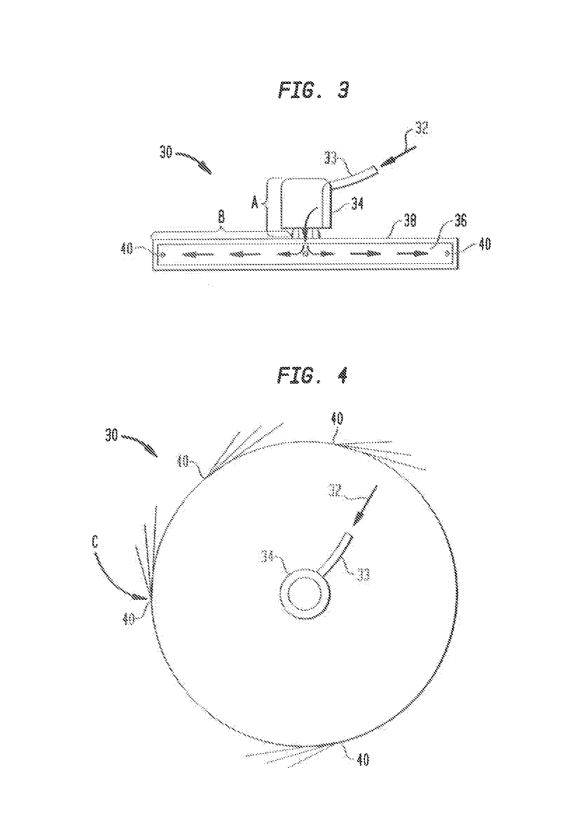

Referring now to FIGS. 3 and 4, an embodiment of snow injection device 30 includes a supply of CO₂ refrigerant fluid 32 delivered in a pipe 33 or conduit, which enters a rotary union 34, proceeds through the internal space 36 of disk 38 and is discharged through the nozzles 40. For purposes of this embodiment, there may be one or a plurality of the nozzles 40, but for simplicity the at least one nozzle 40 is referred to in the plural. The disk 38 is engaged with the rotary union 34 such that the rotary union 34 remains stationary as the disk 38 rotates. The internal space 36 may operate as a conduit for the CO₂ refrigerant fluid 32 as shown, or the internal space 36 may be sized and shaped to receive a conduit or conduits extending along the disk. The internal space 36 would be in fluid communication with the pipe 33. The nozzles 40 are mounted to the periphery of the disk 38 and are in fluid communication with the internal space 36 or conduit therein, The nozzles 40 may be supersonic nozzles and may have discharge orifices at right angles with respect to the disk 38.

As the CO² refrigerant fluid 32 enters the disk 38, it expands and performs work as it moves toward the nozzles 40. The nozzles 40 may increase the velocity of the exiting refrigerant fluid and further serve to increase the efficiency of the refrigeration. apparatus. The CO₂ refrigerant fluid 32 can be either a liquid or a gas as it passes through the disk 38, but upon discharge from the nozzles 40 it flashes into a solid and a gas. As the CO² refrigerant fluid is discharged from the nozzles 40 at a substantially tangential angle, the disk 38 is caused to rotate. At least one of the nozzles 40 is used to rotate the disk 38. The regions A-C show similar energy transfer as that discussed above with respect to FIGS. l-2. Work is performed in region B to rotate the disk 38, such that the CO₂ is exhausted from the region C at its lowest pressure and lowest energy state.

An electrical generator (not shown) may be disposed between the rotary union 34 and the disk 38, actuated by the rotation of the disk 38 as a rotor for the generator. The disk 38 may be operationally connected to or engaged with an electrical generator (not shown) which will function as a mechanical brake and will convert the kinetic energy of the rotating disk 38 into electrical energy. The disk 38, as part of a rotor assembly, may be connected to the electrical generator, in a manner as discussed with respect to the blades 18 in the embodiments of FIGS. 1 and 2.

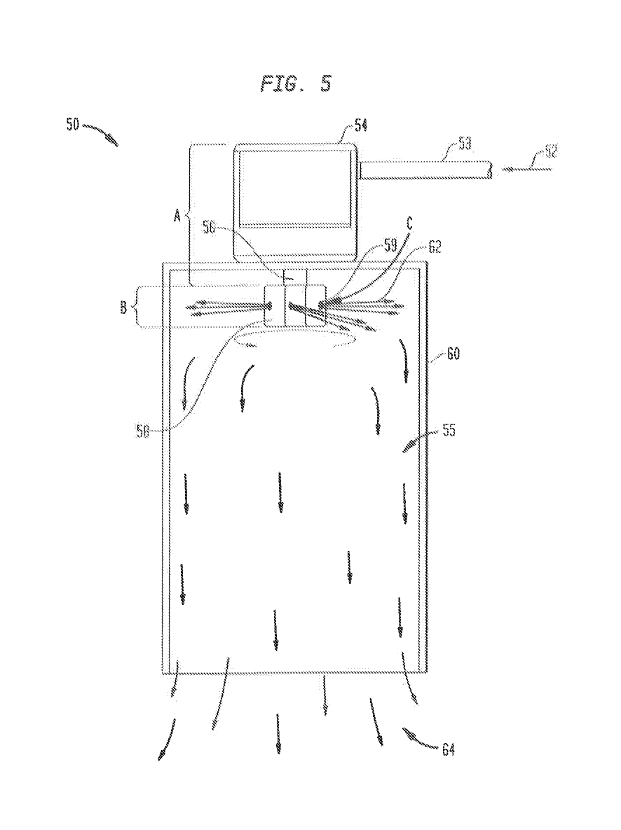

Referring now to FIG. 5, another embodiment of a snow injection device 50 includes a supply of CO₂ refrigerant fluid 52, which enters the rotary union 54 through a pipe 53, proceeds through the threaded connection 56 and into the rotating element 58, where it flashes into a refrigerant discharge 62 of solid and gas. The rotating element 58 may be a disk, cylinder or the like, but any shape that permits uniform rotation of the rotating element 58 may be employed. The refrigerant discharge 62 is exhausted into a chamber 55 defined by a shroud 60, and is substantially slowed in the chamber 55 so that a reduced or lower velocity snow 64 will be provided as the discharge exits the chamber 55. The rotating element 58 is engaged with the rotary union 54 such that the rotary union 54 remains stationary as the rotating element 58 rotates. The rotating element 58 may include one or more nozzles 59 which flash the refrigerant fluid into solid and gas. The nozzle(s) 59 of the rotating element 58 may be supersonic nozzles and may have discharge orifices at right angles with respect to the body of the rotating element 58.

The nozzle(s) of the rotating element 58 also increase the velocity of the exiting refrigerant fluid and further serve to increase the efficiency of the refrigerator. The CO₂ refrigerant fluid 52 can be either a liquid or a gas as it passes through the rotating element 58, but upon discharge from the rotating element 58 it flashes into a solid and a gas. As the CO₂ refrigerant fluid is discharged 62 from the rotating element 58 at a substantially tangential angle with respect to the, body of the rotating nozzle 59, the rotating element 58 is caused to rotate. The regions A-C show similar energy transfer as that discussed above with respect to FIGS. 1-2. Work is performed in region B to rotate the element 58, such that the CO₂ is exhausted from the region C at its lowest pressure and lowest energy state.

An electrical generator may be disposed between the rotary union 54 and the rotating element 58, actuated by the rotation of the rotating element 58 as a rotor for the generator. The rotating element 58 may be operationally connected to or engaged with an electrical generator (not shown) which will function as a mechanical brake and will convert the kinetic energy of the rotating element 58 into electrical energy. The rotating element 58, as part of a rotor assembly, may be connected to the electrical generator, as discussed with respect to the embodiments of FIGS. 3 and 4. The embodiments of FIGS. 1-4 may be substituted for the rotating element 58.

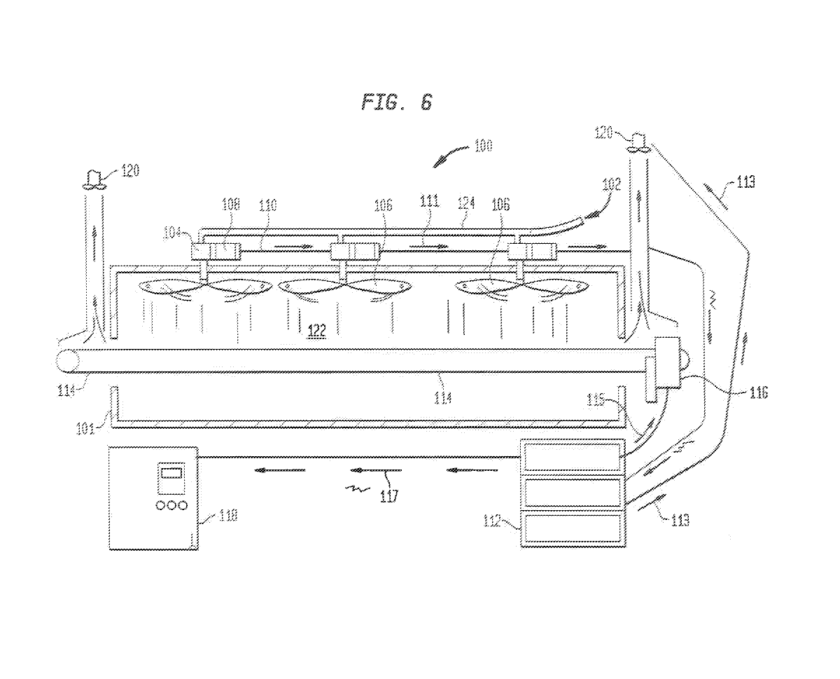

FIG. 6 shows an embodiment of the present refrigeration apparatus comprising a tunnel freezer 100 employing fans 106 such as those shown in FIGS. 1 and 2. It will be understood that a single fan 106 may be present in the tunnel freezer 100, and that the fan(s) 106 of the tunnel freezer 100 may be substituted on an individual basis by snow injection devices, such as those shown in FIGS. 3-5.

The tunnel freezer 100 includes a housing 101 in which a freezing chamber 122 is provided and through which a conveyor 114 powered by a conveyor motor 116 moves to transfer products such as food products through the freezing chamber 122 of the tunnel freezer 100. At least one fan 106 is mounted in the freezing chamber 122, Each of the rotary unions 104 for a respective fan 106 is in fluid communication with a refrigerant conduit 124 which carries the refrigerant fluid 102, such as liquid CO₂ from a remote source (not shown). Each of the rotary couplings 104 is in mechanical communication with an electrical generator 108 which harvests the kinetic energy of the rotating fan 106 and converts it into electrical energy. The electrical generators 108 are in electrical communication with an electrical conduit 110 which may transfer the electrical energy, shown generally by arrows 111, generated by the electrical generators 108 to an electricity storage means 112, such as a battery. The electrical energy stored in the storage means 112 may be used to provide electrical energy, shown generally by arrows 113, to an exhaust fan 120, the conveyor motor 116 as shown generally by arrow 115, and/or a control panel 118 as shown generally by arrows 117. The control panel 118 may monitor the operation of the tunnel freezer 100, including the electricity generated by the fan/ generator assemblies and the electrical load stored by the storage means 112.

Another apparatus for converting the high energy state of the liquid cryogen (CO₂) to a lower energy state for refrigeration is shown in FIGS. 9, Referring thereto, a turbine apparatus of the present embodiments is shown generally at 200.

The turbine apparatus 200 includes a housing 210 having an internal space 212 therein arid in Which is mounted an impeller 214 for rotational movement within the space. The impeller 214 includes at least one and for most applications a plurality of vanes 216, with the impeller 214 rotating about a shaft 218 disposed in and extending through the housing 210. Bearings 224 support the shaft 218 for its rotational movement and transfer of such action to the impeller 214.

The housing 210 includes an inlet 220 in communication with the internal space 212, and an outlet 222 also in communication with the internal space.

Referring in particular to FIG. 9, the turbine apparatus 200 is mounted for example to a roof 226 of a freezer by a support member 228 which is also constructed and arranged to support a generator 230 in operational proximity to the turbine apparatus. Electrical conduits 232 are connected to the generator 230 for providing electricity to any number of ancillary components of the freezer or otherwise. The apparatus 200 is mounted external to the freezer chamber 238.

An inlet pipe 233 is in fluid communication with a source (not shown) of liquid CO₂ and the inlet 220 of the apparatus 200, while an outlet pipe 234 is in fluid communication with the outlet 222 of the apparatus. The outlet pipe 234 extends through the freezer roof 226 into a freezer chamber 238. The outlet pipe 234 is in fluid communication with a manifold 236 which has at least one or a plurality of nozzles 240 to provide a cryogen spray or CO₂ snow.

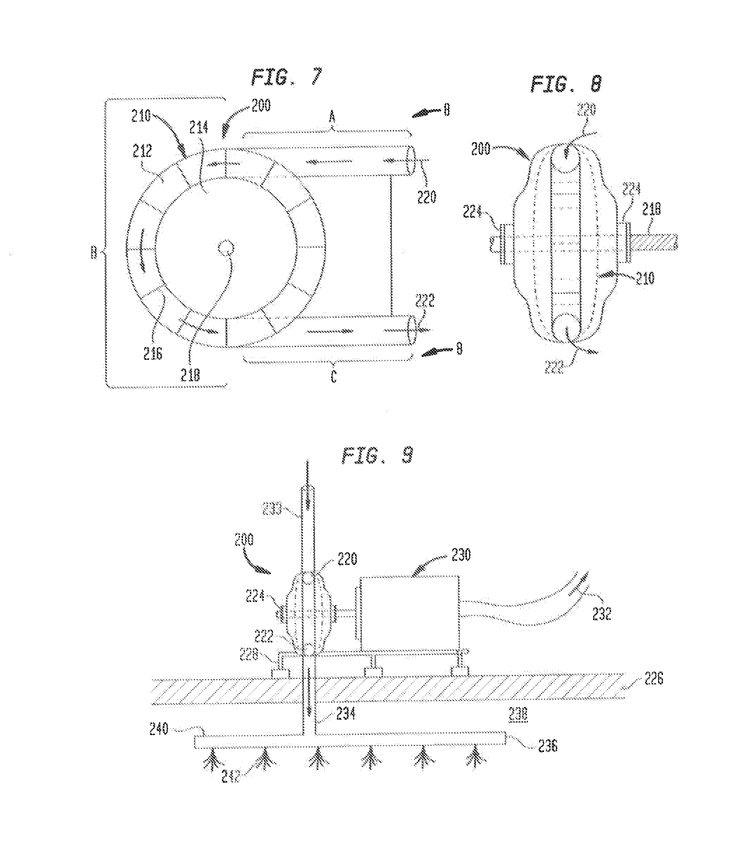

In operation, liquid cryogen, such as CO₂, is introduced into the turbine apparatus 200. The liquid CO₂ enters the turbine region “A” at a high energy state. As it engages the blades of the turbine it enters the region “B”, and in this region work is done by the refrigerant and energy is transferred out of the device. Referring again to the embodiment at FIG. 7, the CO₂ in region B is at a pressure and an energy state lower than it was in region A. In this stage, the liquid CO₂ is subcooled (enthalpy reduced) as work is done by the fluid. At region “C” the fluid leaves the turbine at a lower energy state than region “A” and travels into the piping system of the freezer where it can be injected into the freezing chamber. Due to the construction of the internal space 212 and the vanes 216, work is being performed along an entire path of region B in the internal space 212.

### Example

As mentioned above, a single fan 10 has been shown to generate in excess of 1.5 horsepower (HP). The 1.5 HP is equivalent to 3818 BTU/hr. With a flow rate of 166 lbs. of CO₂ per hour being passed through the apparatus during the test, CO₂ liquid at this flow rate will normally result in a 166 lbs./hr—121 BTU/lbs=20,086 BTU/hr. The amount of energy removed in the process to power the fan is 3818 BTU/hr (1.5 horsepower (HP)=3818 btu/hr). This energy is removed from the cryogenic fluid (CO₂), thereby now producing 23,904 BTU/hr of refrigeration versus the 20,086 BTU/hr without the fan for a total increase of 19 percent in refrigeration, with the added benefit of no electricity required to power the fan.

For all the inventive embodiments of FIGS. 1-9, the transition of the liquid CO₂ from region B to region C causes the CO₂ snow to be exhausted from the region C at its lowest pressure and energy state.

in effect, the present inventive embodiments provide an energy conversion apparatus (for example, fan, turbine) for an intermittent step of doing mechanical work with high pressure cryogen before same is injected into a freezer chamber 238. The power generated from the generator 230 can be used to power ancillary equipment or other equipment of the freezer. The high energy state of the liquid cryogen is reduced prior to it being introduced into the freezing chamber 238 at which point the liquid cryogen now produces an increased amount of CO₂ snow which is in a phase that provides a higher heat transfer rate for any product, such as food products, when the snow comes in contact with. in the freezer. The turbine apparatus 200 may be used with or substituted for the rotary unions 104, fans 106 and generator 108 of the tunnel freezer 100 in FIG. 6.

The refrigerant fluid referred to in the above tunnel freezer and fan embodiments may be CO₂ which may be either in liquid or gas form, or a mixture thereof.

When liquid CO₂ is used as the refrigerant fluid, the fan and disk embodiments discussed above may subcool the liquid CO₂ before it is discharged from the fan. This subcooling results in a reduction in the energy state of the CO₂, which increases the solid to gas proportion of the CO₂ when it is discharged from the nozzle(s) of the fan or disk.

It has been shown that the solid proportion of CO₂ discharged from the present fan embodiments may be from about 52% to about 57%, whereas traditional, stationary injection devices typically realize a solid proportion of from about 47% to about 48%. Without wishing to be limited by theory, it is believed that when using traditional, stationary injection devices, much of the potential energy contained in the liquid CO₂ is converted into heat, which provides 47-48% solid CO₂ upon flashing into a lower pressure volume. When utilizing the present Jim embodiments, energy is removed from the liquid CO₂ in order to perform work to rotate the devices. This results in subcooling, of the liquid CO₂ which is accompanied by a decrease in temperature. Because the temperature of tie liquid CO₂ is lower, about 52-57% solid CO₂ is produced upon flashing. Additionally, the energy produced by the rotation of the present fans may be utilized for other purposes. An increased proportion of solid created by the present fans increases the efficiency of a refrigeration system in which the fans are used, because the solid CO₂ provides better heat transfer than does the gaseous CO₂.

Therefore, a self powered refrigeration apparatus is provided, comprising a refrigeration chamber and at least one fan, comprising at least one blade having an internal space therein through which a refrigerant fluid passes; at least one nozzle in fluid communication with the internal space within each of the at least one blade, wherein the at least one nozzle discharges the refrigerant fluid into the refrigeration chamber at a velocity sufficient to rotate the at least one blade; and an electrical generator operationally connected to the plurality of blades. Alternatively, the fan may comprise a plurality of blades.

Also provided is a self-powered refrigeration apparatus, comprising a refrigeration chamber and at least one snow injection device, comprising a disk having an internal space therein through which a CO₂ refrigerant fluid passes; at least one nozzle in communication with the internal space within the disk which discharges the CO₂ refrigerant fluid from the disk at a velocity sufficient to rotate the disk, the at least one nozzle being adapted to flash the CO₂ refrigerant fluid into gas and solid phases and eject the gas and solid phases into the refrigeration chamber; and an electrical generator operationally connected to the disk. Alternatively, the snow injection device may comprise a plurality of nozzles.

It will be understood that the embodiments described herein are merely exemplary and that a person skilled in the art may make many variations and modifications without departing from the spirit and scope of the invention. All such variations and modifications are intended to be included within the present embodiments as described and claimed herein. It should be understood that the embodiments described above are not only in the alternative, but may be combined.

What is claimed is:

1. An energy conversion apparatus for a freezer, comprising:
a housing having a first region therein for receiving liquid CO₂ at a first pressure and at a first energy state for providing potential energy;
a movable member rotatably mounted to the housing and having a second region in fluid communication with the first region, the second region constructed to receive the liquid CO₂ for changing to a second pressure less than the first pressure, and a second energy state less than the first energy state for providing kinetic energy from which mechanical work is provided to rotate the movable member; and
a discharge member connected to the movable member and having a third region in fluid communication with the second region, the third region continuing the mechanical work when. exhausting the liquid CO₂ at a third pressure less than the second pressure, and at a third energy state less than the second energy state such that the liquid CO₂ is changed to a CO₂ snow.

2. The apparatus of claim 1, wherein the movable member is selected from the group consisting of a fan, disk, cylinder and turbine.

3. The apparatus of claim 1, wherein the movable member comprises an internal space interconnecting the first and second regions for providing the fluid communication.

4. The apparatus of claim 1, wherein the discharge member comprises a nozzle.

5. The apparatus of claim 1, further comprising a freezing chamber for freezing a product, and the movable member being disposed in said freezing chamber.

6. The apparatus of claim 1, wherein the freezer is a food freezer, and the freezing chamber is disposed within the food freezer.

7. The apparatus of claim 1, further comprising a freezing chamber for freezing a product, and the discharge member comprises an outlet pipe in fluid communication with the freezing chamber in which the CO₂ snow is provided.

8. The apparatus of claim 7, wherein the movable member is disposed external to the freezing chamber.

9. The apparatus of claim 1, further comprising a generator electrically connected to the movable member for receiving, the kinetic energy.

10. The apparatus of claim 1, wherein the discharge member comprises a nozzle.

11. A method of energy conversion for a freezer, comprising:
providing liquid CO₂ at a first pressure and at a first energy state to a first region for providing potential energy;
expanding the liquid CO₂ to a second pressure less than the first pressure, and to a second energy state less than the first energy state in a second region in fluid communication with the first region for providing kinetic energy for performing mechanical work in the second region; and
exhausting the liquid CO₂ as a CO₂ snow at a third pressure less than the second pressure, and at a third energy state less than the second energy state from a third region in fluid communication with the second region.

12. The method of claim 11, wherein the providing and the expanding occur external to the freezer.

13. The method of claim 11, further comprising generating electricity from the mechanical work of the expanding liquid CO₂.

14. The method of claim 11, wherein the third region comprises a nozzle.
